(19) United States
(12) Patent Application Publication
(10) Pub. No.: US 2015/0252219 A1
(43) Pub. Date: Sep. 10, 2015

(54) STORAGE-STABLE AQUEOUS REACTIVE COMPOSITIONS BASED ON BETA-HYDROXYALKYLAMIDES

(71) Applicants: Emmanouil Spyrou, Schermbeck (DE); Evelyn Albrecht, Recklinghausen (DE); Annegret Lilienthal, Dorsten (DE); Iris Brueckner, Dorsten (DE); Wiebke Stache, Herten (DE); Stephen Parkyn, Chester (GB)

(72) Inventors: Emmanouil Spyrou, Schermbeck (DE); Evelyn Albrecht, Recklinghausen (DE); Annegret Lilienthal, Dorsten (DE); Iris Brueckner, Dorsten (DE); Wiebke Stache, Herten (DE); Stephen Parkyn, Chester (GB)

(73) Assignee: Evonik Industries AG, Essen (DE)

(21) Appl. No.: 14/430,332

(22) PCT Filed: Aug. 23, 2013
(86) PCT No.: PCT/EP2013/067513

§ 371 Date: Mar. 23, 2015

(30) Foreign Application Priority Data
Oct. 4, 2012 (DE) 10 2012 218 079.6

(51) Int. Cl. C09D 175/12; C08K 5/20; C09J 175/12

(52) U.S. Cl. CPC C09D 175/12; C09J 175/12; C08K 5/20

(57) ABSTRACT

The invention relates to an aqueous composition, comprising

A a water-soluble or water-dispersible binder, or a water-soluble or water-dispersible component containing carboxyl groups, and
B at least one cyclic hydroxyalkylamide.

The invention relates to storage-stable aqueous reactive compositions based on cyclic β-hydroxyalkylamides.

β-Hydroxyalkylamides (HAA) as cross-linkers for coating, adhesive and sealant systems are known. Owing to the low equivalent weight, the high functionality and the simple preparability, β-hydroxyalkylamides have found a wide applicability in recent years, primarily as cross-linkers for powder coating systems, and foremost here is bis(N,N-di-β-hydroxyethyl)adipamide. These are predominantly used in non-aqueous systems. The use of β-hydroxyalkylamides in aqueous systems was also described a long time ago, for example in U.S. Pat. No. 4,076,917 from 1978. In contrast to powder coatings, β-hydroxyalkylamides have not, however, become established in aqueous systems. This is especially due to the lack of stability to hydrolysis of conventional β-hydroxyalkylamides.

Owing to the disadvantages of β-hydroxyalkylamides described above, it would be desirable to be able to use this product class as cross-linkers also in aqueous systems.

It was therefore an object of the invention to find cross-linkers having an increased storage stability in aqueous compositions, particularly still having consistent product properties after 6 weeks at 50° C. and—after curing—able to achieve chemical-resistant coatings.

It has been found, surprisingly, that cyclic hydroxyalkylamides fulfil this objective.

The patent therefore relates to a reactive aqueous composition comprising

A a water-soluble or water-dispersible binder, or a water-soluble or water-dispersible component containing carboxyl groups, and
B at least one cyclic hydroxyalkylamide.

The term “a water-soluble or water-dispersible binder” also includes mixtures of water-soluble and/or water-dispersible binders.

The water-soluble or water-dispersible binder is preferably a coating binder or a coating binder component. Water-soluble or water-dispersible polyacrylates containing carboxyl groups are suitable as binders, particularly those in the molecular weight range 1000 to 10 000, and also water-dispersible, optionally urethane-modified polyester resins containing carboxyl groups. Such polyester resins are known from polyester and alkyd resin chemistry. In the scope of the invention, all water-soluble or water-dispersible binders having groups reactive towards β-hydroxyalkylamides are suitable as reaction partners for cyclic β-hydroxyalkylamides.

Water-soluble or water-dispersible components containing carboxyl groups are all monomeric, oligomeric or polymeric substances having at least one, preferably at least two carboxylic acid groups, the substances giving rise to stable solutions or dispersions in water either with or without internal or external emulsifiers.

Polymeric water-soluble or water-dispersible binders preferably have a molecular weight range of 1000 to 10 000.

In one preferred embodiment, the water-soluble or water-dispersible component containing carboxyl groups is selected from the group consisting of carboxylic acids and salts thereof, amides and salts thereof, carboxylic esters, carbonyl halides and salts thereof, carboxylic anhydrides, carbamic acids and salts thereof, carbamates such as urethane and salts thereof, polyurethanes, polyureas, polycarbonates and polycaprolactones. The water-soluble or water-dispersible binder is particularly preferably selected from the group consisting of polyurethanes, polyureas, polycarbonates and polycaprolactones.

Suitable binders are also described in Stoye/Freitag: “Lackharze” (Coating resins), Hanser-Verlag 1996, Munich and in Westhues: “Polyurethanes”, Vincentz-Verlag, 2007, Hannover.

All substances are useful as component B which have at least one saturated cyclic hydrocarbon residue and/or at least one heterocycle residue. Suitable heteroatoms may be selected from the group consisting of nitrogen, oxygen and sulphur.

The saturated cyclic hydrocarbon residue and/or the heterocycle residue have at least one hydroxyalkylamide residue as substituents. The hydroxyalkylamide residue is preferably a β-bis(N,N-hydroxyalkyl)amide residue.

In one embodiment, the cyclic hydroxyalkylamide is a hydroxyalkylamide of the formula I

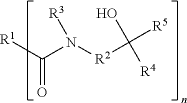

where
R¹ is a saturated cyclic hydrocarbon residue or a heterocycle residue;
R² is alkylene, may be linear, branched or cyclic and preferably has one to 7 carbon atoms, particularly preferably one or two carbon atoms. n is a whole number between 1 and 6.
R³, R⁴ and R⁵ are independently hydrogen, alkyl, alkenyl, alkynyl or aryl, where alkyl, alkenyl and alkynyl may be linear, branched and cyclic and preferably have one to 14 carbon atoms, particularly preferably 2 to 7 carbon atoms and where alkyl, alkenyl, alkynyl or aryl may be substituted. Suitable substituents are mentioned below. R⁴ can form a ring or ring system with R² and/or R⁵. Preference is given to a C5 or C6 ring.

R⁴ and R⁵ are preferably hydrogen.

In a preferred embodiment, R³ is R²CR⁴R⁵OH, preferably R²CH₂OH.

The saturated cyclic hydrocarbon residue and/or the heterocycle residue preferably bears at least two β-bis(N,N-hydroxyalkyl)amide residues. Rings having at least two β-hydroxyethylamide groups are preferred as component B.

The ring size of the saturated cyclic hydrocarbon residue and/or the heterocycle residue may be between four and ten atoms. In a preferred embodiment, the ring size is five to eight atoms, particularly preferably six atoms. Six-membered hydrocarbon rings are especially preferred.

The ring may bear further substituents in addition to the hydroxyalkylamide residues. Further substituents are preferably selected from the group consisting of alkyl, alkenyl, alkynyl, aryl, halogen, functional groups such as ester, alcohol, ether, urethane, urea, amide and unsaturated groups such as double bonds or triple bonds. Alkyl, alkenyl and alkynyl may be linear, branched and cyclic and preferably have one to 14 carbon atoms, particularly preferably 2 or 3 to 8 carbon atoms. Alkyl, alkenyl, alkynyl and aryl may have heteroatoms such as oxygen, nitrogen and sulphur. Alkyl, alkenyl, alkynyl and aryl may be substituted. Suitable substituents are alkyl, alkenyl, alkynyl, aryl, halogen, functional groups such as ester, alcohol, ether, urethane, urea and amide, where alkyl, alkenyl, alkynyl and aryl are as defined above.

Suitable hydroxyalkyl residues are preferably selected from the group consisting of β-hydroxyethyl residue or β-hydroxypropyl residue.

In one particularly preferred embodiment, the hydroxyalkyl residue is a β-hydroxyethyl or β-hydroxypropyl residue.

The at least one cyclic hydroxyalkylamide is particularly preferably a positional isomer selected from the group consisting of 1,2-bis(N,N-di-β-hydroxyethyl)cyclohexanediamide, 1,3-bis(N,N-di-β-hydroxyethyl)cyclohexanediamide and 1,4-bis(N,N-di-β-hydroxyethyl)cyclohexanediamide.

The aqueous composition according to the invention may comprise auxiliaries and additives as component C.

Conventional additives, such as levelling agents, e.g. polysilicones or acrylates, light stabilisers, sterically hindered amines for example, or other auxiliaries, as have been described in EP 0 669 353 for example, in a total amount of 0.05 to 5% by weight, catalysts, stabilisers, devolatilisers, emulsifying auxiliaries and dispersing additives may be added as optional component C. Fillers and pigments, such as titanium dioxide, may be added in an amount of up to 50% by weight of the total composition. Organic solvents are also suitable as auxiliaries. Liquid substances which do not react with other ingredients, e.g. acetone, xylene, Solvesso 100, Solvesso 150, dioxane, DMF, butyl acetate, methoxypropyl acetate, may be added to the aqueous composition according to the invention. These solvents are only used as cosolvents and make up only a relatively small proportion in comparison with the main solvent, water. The ratio by volume of water:cosolvent is preferably more than 2:1 and is preferably in the range of 100:1 to 10:1.

Components A and B and optionally C are added together or optionally added independently as aqueous solutions and stirred in a suitable amount of water, if necessary with the aid of suitable stirring devices, until a stable solution, emulsion or dispersion is formed. In one embodiment, the aqueous composition according to the invention has a solids concentration of 20 to 80%.

In a preferred embodiment, components A and B have a weight ratio A:B in the range of 1:1 to 1000:1. The weight ratio A:B is preferably in the range of 5:1 to 200:1, more preferably in the range of 10:1 to 350:1. In a particularly preferred embodiment, the weight ratio A:B is in the range of 15:1 to 35:1. In another particularly preferred embodiment, the weight ratio A:B is in the range of 25:1 to 65:1.

The aqueous composition according to the invention is stable on storage for at least 6 weeks at 50° C. Stable means that the aqueous composition according to the invention does not become solid during storage and the viscosity of the aqueous composition according to the invention does not significantly increase during storage; i.e., the increase in the viscosity is 100% or less following storage for 6 weeks. The viscosity of non-stable compositions, in contrast, increases by more than 100% on storage for six weeks or the composition solidifies.

Cyclic hydroxyalkylamides, according to the invention, are used as cross-linkers in aqueous compositions, preferably in storage-stable aqueous compositions.

For the use of reactive aqueous compositions as coating, adhesive or sealant material, an aqueous composition is applied which comprises component B and preferably components A and B. In a further step, the composition can optionally be freed from water at a moderate temperature, preferably in the range of 20 to 100° C., and finally be cured, preferably at temperatures of around 130 to 230° C. The coating, adhesive or sealant materials formed according to the invention have a chemical resistance of at least 150 MEK double rubs, even after storage of the reactive composition used for 6 weeks at 50° C. A coating, adhesive or sealant material is deemed to be chemical resistant if it is resistant to rubbing with a 1 kg-weighted piece of cotton wool soaked in methyl ethyl ketone for at least 150 double rubs (“MEK double rubs”).

The invention is further illustrated by the following examples.

### EXAMPLES

### Example 1

Preparation of the Polyurethane Dispersion (PUD) (Component A)

739 g of oxyester T1136 (OH polyester, Evonik), 70.9 g of dimethylolpropionic acid (Aldrich), 18.9 g of trimethylolpropane (Aldrich) and 0.66 g of dibutyltin dilaurate (Aldrich) were dissolved in 330 g of acetone heated to 50° C. and treated with 490 g of isophorone diisocyanate in portions (Evonik). The addition was completed after 20 min and the mixture was maintained under reflux with stirring for 4 h. The reaction is then terminated and the solution is cooled. The free NCO content is 3.9% (theory 3.84%).

150 ml of acetone is added to 250 g of this solution and is then admixed with a solution of 5.5 g of ethylenediamine (Aldrich) in 20 ml of acetone. After 15 seconds, 8.1 g of triethylamine (Aldrich) is added and, after a further 15 seconds, 397 ml of distilled water is added, each time with stirring. After a further 2 minutes of stirring, the acetone was removed under reduced pressure in a rotary evaporator. After filtration through a 50 μm filter, the polyurethane dispersion is ready for use. The pH is 7.8 and the viscosity ca. 30 mPas.

### Example 2

Preparation of the Mixtures

To each 100 parts of PUD are mixed

a) 3.8 parts of cyclic 1,4-bis(N,N-di-β-hydroxyethyl)cyclohexanediamide and
b) 3.5 parts of linear Vestagon HA320 (Evonik, bis(N,N-di-β-hydroxyethyl)adipamide).

The preparation of cyclic 1,4-bis(N,N-di-β-hydroxyethyl)cyclohexanediamide is carried out according to KR 10-2009-0111720 (application number 10-2008-0037454), translated title “CYCLOALKANE DICARBOXAMIDE COMPOUNDS, THEIR PREPARATION AND APPLICATION” and J. Korean In Eng. Chem., Vol. 20, No. 2, April 2009, 195-200.

These mixtures and also PUD without β-hydroxyalkylamide (HAA) are each stored for one week, two, four and six weeks at 50° C. After storage, each reactive composition is knife-coated (30 μm dry film layer thickness) onto a steel panel (Gardobond 722 W OE), evaporated for 10 min at 50° C. and finally baked for 30 min at 160° C. The MEK resistance is then determined.

### Example 3

Testing of Chemical Resistance (MEK Double Rubs) Following Storage for 1, 2, 4 and 6 Weeks at 50° C.

| | Storage time (50° C.) | | | |
|---|---|---|---|---|
| | 1 W | 2 W | 4 W | 6 W |
| a) cyclic HAA | 150 | 150 | 150 | 150 |
| b) linear HAA* | 150 | 150, adhered | 150, adhered | solution |
| | | | | solidified! |
| c) without HAA* | 150 | 60 | 10 | ** |

*non-inventive comparative examples
** Measurement is not possible. The solution cannot be applied as it has solidified.

Without additive, even the PUD stored for two weeks (2 W) at 50° C. loses its chemical resistance after curing. In the non-inventive comparison b) (non-cyclic β-hydroxyalkylamides), the coating remains chemical-resistant but already begins to adhere after two weeks at 50° C., and after six weeks (6 W) the reactive composition has solidified and can no longer be knife-coated. Only the inventive composition a) based on cyclic β-hydroxyalkylamides (HAA) is storage-stable and forms chemical-resistant coatings even after storage for six weeks at 50° C.

1. Aqueous composition, comprising
A a water-soluble or water-dispersible binder, or a water-soluble or water-dispersible component containing carboxyl groups, and
B at least one cyclic hydroxyalkylamide.

2. Aqueous composition according to claim 1, wherein the cyclic hydroxyalkylamide comprises at least one saturated cyclic hydrocarbon residue having at least one β-bis(N,N-hydroxyalkyl)amide residue, preferably at least two β-bis(N,N-hydroxyalkyl)amide residues, as substituents and/or at least one heterocycle residue having at least one β-bis(N,N-hydroxyalkyeamide residue, preferably at least two β-bis(N,N-hydroxyalkyl)amide residues, as substituents.

3. Aqueous composition according to claim 1, wherein the at least one cyclic hydroxyalkylamide is selected from the group consisting of β-hydroxyethylamide and β-hydroxypropylamide.

4. Aqueous composition according to claim 2, wherein the at least one saturated cyclic hydrocarbon residue and/or the at least one heterocycle residue has a ring size of 4 to 10 atoms, preferably 5 to 8 atoms, particularly preferably six atoms.

5. Aqueous composition according to claim 2, wherein the at least one saturated cyclic hydrocarbon residue and/or the at least one heterocycle residue comprises further substituents preferably selected from the group consisting of alkyl, alkenyl, alkynyl, aryl, halogen, functional groups such as ester, alcohol, ether, urethane, urea, amide and unsaturated groups such as double bonds or triple bonds.

6. Aqueous composition according to claim 1, wherein the at least one cyclic hydroxyalkylamide is selected from the group consisting of 1,2-bis(N,N-di-β-hydroxyethyl)cyclohexanediamide, 1,3-bis(N,N-di-β-hydroxyethyl)cyclohexanediamide and 1,4-bis(N,N-di-β-hydroxyethyl)cyclohexanediamide.

7. Aqueous composition according to claim 1, wherein the water-soluble or water-dispersible binder is a monomeric, oligomeric or polymeric substance, preferably selected from the group consisting of carboxylic acids and salts thereof, amides and salts thereof, carboxylic esters, carbonyl halides and salts thereof, carboxylic anhydrides, carbamic acids and salts thereof, carbamates such as urethane and salts thereof, polyurethanes, polyureas, polycarbonates and polycaprolactones.

8. Aqueous composition according to claim 1, wherein the water-soluble or water-dispersible binder is selected from the group consisting of polybutadiene, polyurethanes, polyureas, polycarbonates and polycaprolactones.

9. Aqueous composition according to claim 1, further comprising
C auxiliaries and/or additives, preferably selected from the group consisting of levelling agents, light stabilisers, catalysts, stabilisers, devolatilisers, emulsifying auxiliaries, dispersing additives, fillers and pigments.

10. Aqueous composition according to claim 1, wherein components A and B have a weight ratio A:B in the range of 1:1 to 1000:1, preferably in the range of 5:1 to 200:1, more preferably in the range of 10:1 to 350:1, particularly preferably in the range of 15:1 to 35:1, also particularly preferably in the range of 25:1 to 65:1.

11. Use of cyclic hydroxyalkylamides as cross-linkers in aqueous compositions, preferably in storage-stable aqueous compositions.

12. Use of the aqueous composition according to claim 1 as coating, adhesive or sealant material for preparing coatings, adhesives or sealants, preferably chemical-resistant coatings, chemical-resistant adhesives or chemical-resistant sealants.

13. Coating, adhesive or sealant, prepared using an aqueous composition comprising a cyclic hydroxyalkylamide, preferably using an aqueous composition according to claim 1.

14. Method for preparing a coating, adhesive or a sealant involving applying an aqueous composition comprising a cyclic hydroxyalkylamide, preferably using an aqueous composition according to claim 1.

15. Method according to claim 14, further optionally comprising removal of water from the composition, preferably at a temperature in the range of 20 to 100° C. and curing of the composition, preferably at a temperature in the range of 130 to 230° C.
